(19) United States
(12) Patent Application Publication
(10) Pub. No.: US 2005/0173007 A1
(43) Pub. Date: Aug. 11, 2005

(54) Lever-actuated high-pressure gas tap adjustable to different bottlenecks

(76) Inventors: Gilles Cannet, Parmain (FR); Philippe Pisot, L'Isle Adam (FR)

Correspondence Address: Air Liquide;Intellectual Property Department, Suite 1800, 2700 Post Oak Boulevard, Houston, TX, 77056, US

(21) Appl. No.: 10/516,962

(22) PCT Filed: May 15, 2003
(86) PCT No.: PCT/FR03/01479

(30) Foreign Application Priority Data
Jun. 5, 2002 (FR) 0206898

(51) Int. Cl. F16K 37/00; F16K 1/30

(52) U.S. Cl. 137/557

(57) ABSTRACT

The invention relates to a tap controlling the dispensing of a pressurized fluid, particularly a gas, comprising a valve body (1) that has an axis (XX) and is provided with an internal passage (10) for the fluid, which extends from an inlet port (8) to an outlet port (9), a fastening base (12) which has an axis (XX), coaxially supports the inlet port (8) of the internal passage (10), and the outer periphery of which is threaded, an outlet connection (4) which has an axis (BB) and supports the outlet port (9) of the internal passage (10), a manometer (5) which has an axis (AA) and the pressure-metering means of which is connected to the internal passage (10), an engaging member (11) which is disposed between the manometer (5) and the fastening base (12), and a lever (2) which pivots around an axis (YY) that runs perpendicular to the axis (XX) and cooperates with at least one valve (33) that acts upon the internal passage (10) such that the fluid can circulate or is prevented from circulating from the inlet port (8) to the outlet port (9) of the internal passage (10). The inventive tap is characterized by the fact that the height (H1) between the base of the engaging member (11) and the axis (BB) of the connection (4) ranges between 60 and 75 mm while the height (H3) between the base of the engaging member (11) and the axis (YY) of the lever (2) ranges between 50 and 110 mm. Also disclosed is a gas container comprising such a tap.

On the one hand there are taps with integrated regulators which comprise a lever for controlling the opening or closing of the valve which allows or prevents the gas contained in the bottle to flow to the outside and, on the other hand, taps without a regulator, which are able to be used in a central pressure-regulating station for example, but with an operating lever and optionally a manometer for reading the pressure of the gas contained in the bottle.

If a tap with an integrated regulator justifies the use of a specific protective cap or cowling, which protects the fragile components, allows access to the valve (on/off) and to the device for regulating the expansion pressure, does not interfere with the reading of the manometers and/or allows a guarantee seal to be fitted, then a single tap, intended to replace taps of the handwheel type for example, does not really justify the costly replacement of existing taps.

In a conventional use of an oxyacetylene station, an oxygen bottle and an acetylene bottle are grouped together in a trolley or against a wall and fixed by a chain, and it must be possible to read the manometer, fasten the regulator, adjust the regulator and read the manometers of the regulator without difficulty and without risk.

However, the oxygen bottle is generally higher than the acetylene bottle with the result that access to the tap of the acetylene bottle is difficult on the oxygen bottle side and impossible on the wall side. An additional constraint lies in the fact that it is desirable for reasons of production economy of scale for the taps of the various bottles to be as similar as possible, which leads to the standardization of their components.

In the likewise conventional use of bottles connected by a line and supplying a centralized regulating device for example, the bottles are placed side by side against a wall and it must be possible to fit and remove the connection hoses, actuate the lever, and read the manometer of the tap without being obstructed either by the caps or by the adjacent bottles.

The taps are generally designed to be machined on transfer machines in which it is preferable for all the axes to be orthogonal. This arrangement has the advantage of being more economic in production terms but limits the layout possibilities for the components.

The taps of extinguishers which are commonly equipped with a manometer and with a lever are not covered by a cap and do not receive a regulator.

In the field of industrial gases, there are no taps with a lever.

The problem which has been set was therefore to find an organization of the components of a tap with a lever and with a manometer compatible with caps already existing on the bottles.

The tap/cap assembly must remain secure and convenient both during transportation and filling of the bottle and also during use, which may lead to a plurality of bottles being grouped side by side and often along a wall.

The solution of the invention consists of a tap with a lever adjustable to different bottle caps, in which the relative arrangements of the components accessible to or visible by the user, namely the lever, the manometer and the inlet/outlet connector, solve the problem mentioned above.

The invention thus consists of a tap for a pressurized gas container for controlling the dispensing of a pressurized fluid, in particular a gas, comprising:
a tap body of axis (XX) comprising an internal passage for the fluid, extending between an inlet orifice and an outlet orifice,
a fastening base, of axis (XX), threaded at its external periphery and coaxially bearing the inlet orifice of the internal passage,
an outlet connector of axis (BB) bearing the outlet orifice of the internal passage,
a manometer of axis (AA) whose pressure take-off is connected to the internal passage,
a mounting grip situated between the manometer and the fastening base,
a lever pivoting about an axis (YY) perpendicular to the axis (XX) and cooperating with at least one valve arranged on the internal passage in such a way as to allow or to prevent the circulation of the fluid in said internal passage from the inlet orifice toward the outlet orifice,
characterized in that the height (H1) between the base of the tighening grip and the axis (AA) of the manometer is between 27 and 35 mm, the height (H2) between the base of the tighening grip and the axis (BB) of the connector is between 60 and 75 mm, and the height (H3) between the base of the tighening grip and the axis (YY) of the lever is between 50 and 110 mm.

Depending on the particular case, the tap of the invention may comprise one or more of the characteristics below:
the height (H4) between the base of the tighening grip and the top of the body is between 80 and 120 mm;
the height (H1) is around 30 mm, the height (H2) is around 65 mm, the height (H3) is around 95 mm and/or the height (H4) is around 105 mm;
the axis (XX) of the body and the axis (BB) of the connector are perpendicular;
the angle (A1) between the plane passing through the axis (AA) of the manometer and through the axis (XX) and the plane passing through the axis (CC) of the lever and through the axis (XX) is between 75° and 105°, preferably around 90°;
the angle (A2) between the plane passing through the axis (AA) of the manometer and through the axis (XX) and the plane passing through the axis (BB) of the connector and through the axis (XX) is between 0 and 45°, preferably around 30°;
the lever cooperates with a valve via a movable rod acting on the valve;
the lever pivots about the axis (YY) between at least one rest position in which the valve rests against the seat so as to prevent any exiting of fluid through the connector, and an active position in which the valve is spaced apart from the seat so as to allow the fluid to circulate in the internal passage and to exit via the connector;
the valve is normally pushed back toward a valve seat through the effect of a spring means when the lever is in its rest position.

The invention also relates to a pressurized gas container, in particular a gas bottle, characterized in that it comprises a tap and a protective cowling surrounding all or part of said tap.

The invention will be explained in more detail below with reference to the appended figures, in which:

FIG. 1 is a representation in longitudinal section of a tap for a gas bottle according to the invention,

FIG. 2 is a side view of the tap of FIG. 1,

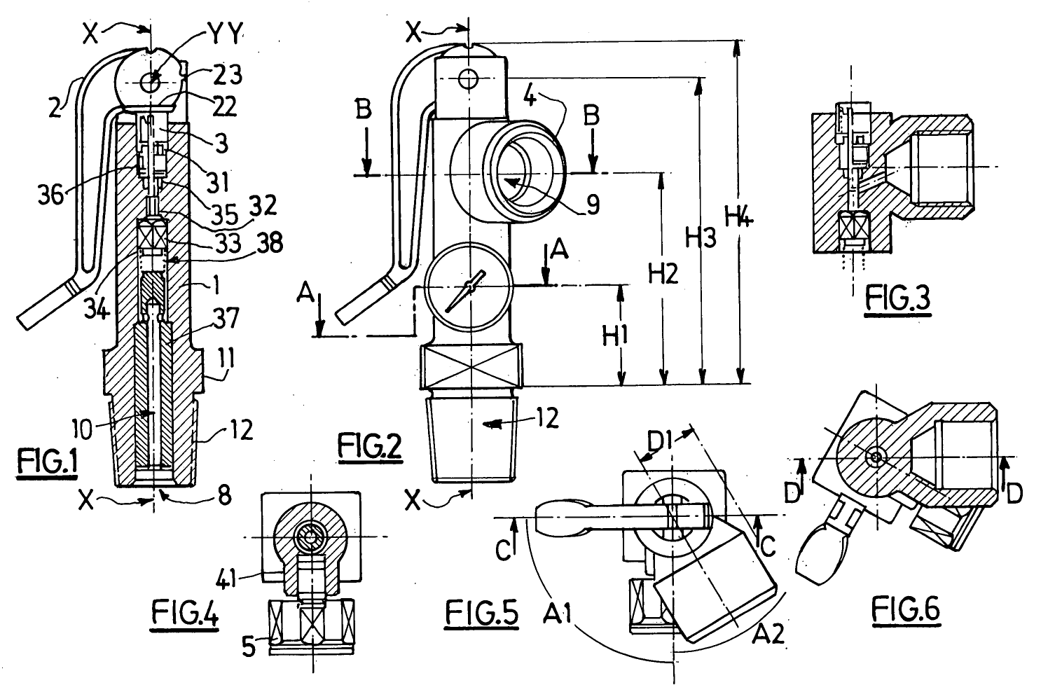

FIG. 3 is a view in section along D-D of FIG. 6,

FIG. 4 is a view in section along A-A of the tap of FIG. 2,

FIG. 5 is a plan view of FIG. 2,

FIG. 6 is a view in section along B-B of FIG. 2,

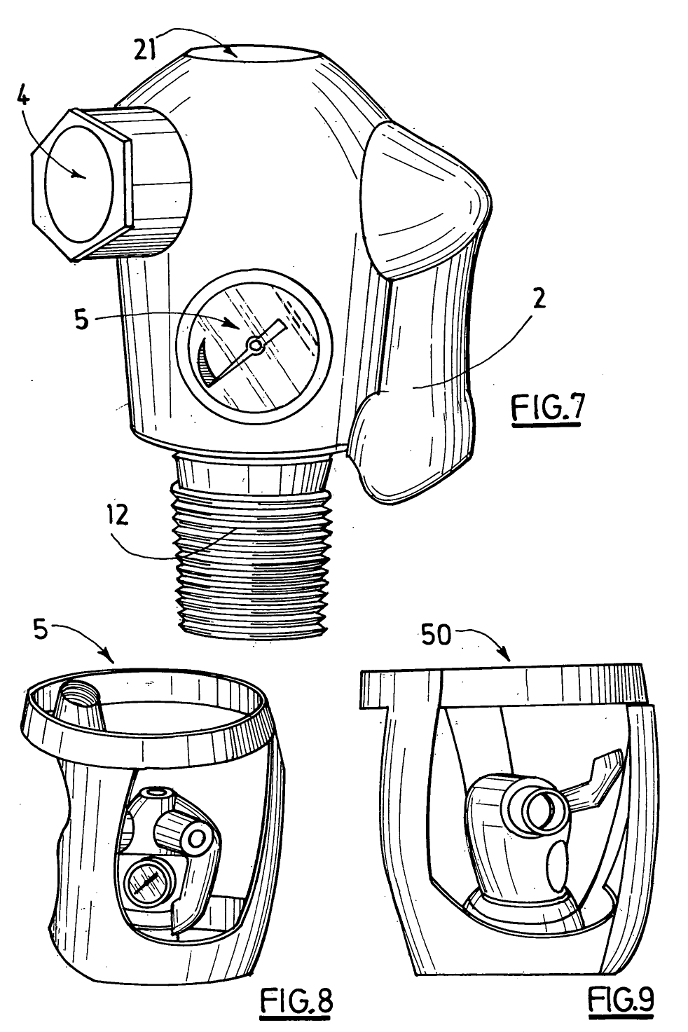

FIG. 7 shows a tap according to the invention covered with a plastic shell 21 serving as a casing for it,

FIG. 8 represents the tap of FIG. 7 inserted into a protective cowling 50, the tap being in the rest position (gas turned off),

FIG. 9 represents the tap of FIG. 7 inserted into a protective cowling 50, the tap being in the active position (gas turned on).

FIG. 1 schematically illustrates a tap according to the invention having a lever 2 and manometer 5 and providing good ergonomics both during filling and emptying of the bottle to which it is fastened and while the bottle is being handled. This tap is composed of a body 1 comprising a mounting grip 11 of square or rectangular cross section, a conical connector 12 for sealed fastening to the bottle, a mount 13 supporting the lever 2 and allowing it to pivot about the pin 21. The lever 2 comprises two flat surfaces 22 and 23 which can bear on a pusher 3 applied against the lever 2 by a spring 31. The pusher 3 is secured to a rod 32. When the lever 2 is in the rest or off position, represented in FIGS. 1 and 2, the assembly formed by the pusher 3 and the rod 32 is in a position in which it is brought closer to the axis (YY). Pivoting the lever 2 such that the surface 23 comes into contact with the pusher 3 causes the assembly 3, 32 to move and, as it moves away from the axis (YY), to enter into contact and then move the valve 33, which leaves its seat 34 and allows the gas to pass through the component 37, from inside the bottle toward the connector 4. A boss 41 of the body 1, which is bored and provided with an internal thread, makes it possible to fasten and to supply gas to the manometer 5, which indicates the pressure of the gas circulating in the tap body 1, and thus also contained in the bottle.

In order to be able to enter a cap, the assembly must pass through a circle with a diameter below 75 mm and be contained in a cylinder centered on the axis of the bottle with a diameter smaller than the inside diameter of the cap, namely 88 mm, and its height H4 must not exceed 110 mm. The double condition of the 75 mm and 88 mm diameters results from the fact that it is possible to imagine a tap such that certain parts are inscribed in a circle of 75 mm diameter, the center of which is not in the axis of the bottle; such a tap is able to be covered only partially by the cap if the distance between the center of said 75 mm circle and the axis of the bottle is greater than 13 mm.

To allow effective use of the lever 2, access to the connector 4 and the possibility of reading the manometer 5 when the tap is protected by a cowling, the angles and distances below have been determined after numerous tests carried out under use conditions (fitting a regulator to the connector 4 without the tail of the regulator striking the manometer 5; operating the lever; adjusting the regulator) with different regulators, under filling conditions and under transportation conditions, with right-handed and left-handed operators of different sizes.

The possible dimensions corresponding to the criteria set within the scope of the invention are given in the tables below.

TABLE 1

| | Maximum | Minimum | Preferred |
|---|---|---|---|
| Height | value (mm) | value (mm) | value |
| H1 | 35 | 27 | 30 |
| H2 | 75 | 60 | 65 |
| H3 | 110 | 50 | 95 |
| H4 | 120 | 80 | 105 |

H1 denotes the height between the base of the tighening grip 11 and the axis of the manometer
H2 denotes the height between the base of the tighening grip 11 and the axis of the connector 4
H3 denotes the height between the base of the tighening grip 11 and the axis of the lever 21
H4 denotes the height between the base of the tighening grip 11 and the top of the tap

TABLE 2

| Offset | Maximum | Minimum | Preferred |
|---|---|---|---|
| D1 | 30 | 0 | 0 |

The offset D1 is that between the axis of the tap (XX) and the axis of the connector 4.

TABLE 3

| Angle | Maximum | Minimum | Preferred |
|---|---|---|---|
| A1 | 105° | 75° | 90° |
| A2 | 45° | 0° | 30° |

The angle A1 is that between the plane passing through the axis of the manometer 5 and the plane passing through the axis of the lever 2.
The angle A2 is that between the plane passing through the axis of the manometer 5 and the plane passing through the axis of the connector 4.

In a variant, if the tap is intended particularly for equipping bottles used in centralized pressure-regulating systems, the connector 4 can be transferred to the back of the tap, in this instance the angle A1 becoming 75° (+/−) and the angle A2 becoming 165° (+/−).

1-10. (canceled)

11. An apparatus which may be used for controlling the dispensing of a pressurized fluid, wherein:
a) said apparatus comprises:
1) a body located about a first axis comprising an internal passage for said fluid, wherein said passage extends between an inlet orifice and an outlet orifice;
2) a fastening base located about said first axis, wherein:
(a) said base is threaded at its external periphery; and
(b) said base is substantially in coaxial connection with said inlet orifice;
3) an outlet connector located about a second axis, wherein said outlet connector is substantially in connection with said outlet orifice;
4) a manometer means located about a third axis, wherein said manometer means comprises a pressure take-off substantially connected to said internal passage;
5) a tightening grip comprising a tightening grip base, wherein said tightening grip is substantially located between said manometer and said fastening base; and
6) a lever located about a fourth axis, wherein
(a) said lever pivots around a fifth axis which is substantially perpendicular to said first axis; and
(b) said lever cooperates with at least one valve means, located on said internal passage, so as to regulate fluid movement between said inlet orifice and said outlet orifice; and
b) the distance between said tightening grip base and said third axis of said manometer is between about 27 mm and about 35 mm;
c) the distance between said tightening grip base and said second axis of said outlet connector is between about 60 mm and about 75 mm; and
d) the distance between said base of said tightening grip base and said fifth axis of said lever is between about 50 mm and about 110 mm.

12. The apparatus of claim 11, wherein said pressurized fluid comprises a gas.

13. The apparatus of claim 11, wherein the distance between said tightening grip base and the top of said body is between about 80 mm and 120 mm.

14. The apparatus of claim 13, wherein:
a) said distance between said tightening grip base and said third axis is about 30 mm;
b) said distance between said tightening grip base and said second axis is about 65 mm;
c) said distance between said tightening grip base and said fifth axis is about 95 mm; and
d) said distance between said tightening grip base and said top of said body is about 105 mm.

15. The apparatus of claim 11, wherein said first axis and said second axis are substantially perpendicular.

16. The apparatus of claim 11, wherein the angle between the plane created by said first axis and said third axis, and the plane created by said first axis and said fourth axis, is between about 75° and about 105°.

17. The apparatus of claim 16, wherein said angle is about 90°.

18. The apparatus of claim 11, wherein the angle between the plane created by said first axis and said third axis; and the plane created by said first axis and said second axis, is less than about 45°.

19. The apparatus of claim 18, wherein said angle is about 30°.

20. The apparatus of claim 11, wherein said cooperation between said lever and said valve means comprises a movable rod acting on said valve means.

21. The apparatus of claim 11, wherein said lever pivots between:
a) at least one resting position wherein said valve means prevents an exiting of said fluid through said connector; and
b) an active position wherein said valve means allows said fluid to circulate through said internal passage and exit through said connector.

22. The apparatus of claim 21, wherein said valve means is normally maintained in a closed position, when said lever is in said resting position, by a spring means.

23. An apparatus which may be used for controlling the dispensing of a pressurized fluid, wherein:
a) said apparatus comprises:
1) a body located about a first axis comprising an internal passage for said fluid, wherein said passage extends between an inlet orifice and an outlet orifice;
2) a fastening base located about said first axis, wherein:
(a) said base is threaded at its external periphery; and
(b) said base is substantially in coaxial connection with said inlet orifice;
3) an outlet connector located about a second axis, wherein said outlet connector is substantially in connection with said outlet orifice and wherein said first axis and said second axis are substantially perpendicular;
4) a manometer means located about a third axis, wherein said manometer means comprises a pressure take-off substantially connected to said internal passage;
5) a tightening grip comprising a tightening grip base, wherein said tightening grip is substantially located between said manometer and said fastening base; and
6) a lever located about a fourth axis, wherein
(a) said lever pivots around a fifth axis which is substantially perpendicular to said first axis and wherein said lever also pivots between:
(1) at least one resting position wherein said valve means prevents an exiting of said fluid through said connector; and
(2) an active position wherein said valve means allows said fluid to circulate through said internal passage and exit through said connector; and
(b) said lever cooperates with at least one valve means, located on said internal passage, so as to regulate fluid movement between said inlet orifice and said outlet orifice, wherein said cooperation between said lever and said valve means comprises a movable rod acting on said valve means; and
b) the distance between said tightening grip base and said third axis of said manometer is about 30;
c) the distance between said tightening grip base and said second axis of said outlet connector is about 65 mm;
d) the distance between said base of said tightening grip base and said fifth axis of said lever is about 95 mm;
e) the distance between said tightening grip base and the top of said body is between about 80 mm and 120 mm;
f) the angle between the plane created by said first axis and said third axis, and the plane created by said first axis and said fourth axis, is between about 75° and about 105°; and
g) the angle between the plane created by said first axis and said third axis; and the plane created by said first axis and said second axis, is less than about 45°.

24. An apparatus which may be used to contain a pressurized gas, wherein:
a) said apparatus comprises a tap, wherein said tap comprises:
1) a body located about a first axis comprising an internal passage for said fluid, wherein said passage extends between an inlet orifice and an outlet orifice;
2) a fastening base located about said first axis, wherein:
(a) said base is threaded at its external periphery; and
(b) said base is substantially in coaxial connection with said inlet orifice;
3) an outlet connector located about a second axis, wherein said outlet connector is substantially in connection with said outlet orifice;
3) an outlet connector located about a second axis, wherein said outlet connector is substantially in connection with said outlet orifice;
4) a manometer means located about a third axis, wherein said manometer means comprises a pressure take-off substantially in connection with said internal passage;
5) a tightening grip comprising a tightening grip base, wherein said tightening grip is substantially located between said manometer and said fastening base;
6) a lever located about a fourth axis, wherein
(a) said lever pivots around a fifth axis which is substantially perpendicular to said first axis;
(b) said lever cooperates with at least one valve means, located on said internal passage, so as to regulate fluid movement between said inlet orifice and said outlet orifice; and
7) a protective covering surrounding at least part of said tap; and
b) the distance between said tightening grip base and said third axis of said manometer is between about 27 mm and about 35 mm;
c) the distance between said tightening grip base and said second axis of said outlet connector is between about 60 mm and about 75 mm;
d) the distance between said base of said tightening grip base and said fifth axis of said lever is between about 50 mm and about 110 mm; and
e) said tap is substantially covered with a protective covering.
